(19) United States
(12) Patent Application Publication
(10) Pub. No.: US 2020/0192898 A1
(43) Pub. Date: Jun. 18, 2020

(54) MULTI-TENANT STORAGE FOR ANALYTICS WITH PUSH DOWN FILTERING

(71) Applicant: Amazon Technologies, Inc., Seattle, WA (US)

(72) Inventors: Andrew Edward CALDWELL, Santa Clara, CA (US); Anurag GUPTA, Atherton, CA (US); Adam S. HARTMAN, San Jose, CA (US); Nigel Antoine GULSTONE, San Jose, CA (US)

(21) Appl. No.: 16/220,824

(22) Filed: Dec. 14, 2018

(51) Int. Cl. G06F 16/2453; G06F 16/2458; G06F 16/2455; G06F 17/50; H04L 29/08

(52) U.S. Cl. CPC G06F 16/24535; G06F 16/2471; G06F 16/24542; G06F 17/5027; H04L 67/1097; G06F 16/24568

(57) ABSTRACT

Techniques for multi-tenant storage for analytics with push down filtering are described. A multi-tenant storage service can include resources can be grouped into racks, with each rack providing a distinct endpoint to which client services may submit queries. Each rack may include interface nodes and storage nodes. The interface nodes can preprocess queries that are received by splitting them into chunks to be executed by the storage nodes. Each storage node includes a field programmable gate array (FPGA) and a CPU. The CPU can receive the operations and convert the operations into instructions that can be executed by the FPGA. The instructions may include pointers to data and operations for the FPGA to perform on the data. The FPGA can process the data stream and return the results of the processing which are returned via the interface node.

### BACKGROUND

Many companies and other organizations operate computer networks that interconnect numerous computing systems to support their operations, such as with the computing systems being co-located (e.g., as part of a local network) or instead located in multiple distinct geographical locations (e.g., connected via one or more private or public intermediate networks). For example, data centers housing significant numbers of interconnected computing systems have become commonplace, such as private data centers that are operated by and on behalf of a single organization, and public data centers that are operated by entities as businesses to provide computing resources to customers. Some public data center operators provide network access, power, and secure installation facilities for hardware owned by various customers, while other public data center operators provide “full service” facilities that also include hardware resources made available for use by their customers. However, as the scale and scope of typical data centers has increased, the tasks of provisioning, administering, and managing the physical computing resources have become increasingly complicated.

The advent of virtualization technologies for commodity hardware has provided benefits with respect to managing large-scale computing resources for many customers with diverse needs, allowing various computing resources to be efficiently and securely shared by multiple customers. For example, virtualization technologies may allow a single physical computing machine to be shared among multiple users by providing each user with one or more virtual machines hosted by the single physical computing machine, with each such virtual machine being a software simulation acting as a distinct logical computing system that provides users with the illusion that they are the sole operators and administrators of a given hardware computing resource, while also providing application isolation and security among the various virtual machines. Furthermore, some virtualization technologies are capable of providing virtual resources that span two or more physical resources, such as a single virtual machine with multiple virtual processors that spans multiple distinct physical computing systems. As another example, virtualization technologies may allow data storage hardware to be shared among multiple users by providing each user with a virtualized data store which may be distributed across multiple data storage devices, with each such virtualized data store acting as a distinct logical data store that provides users with the illusion that they are the sole operators and administrators of the data storage resource.

### BRIEF DESCRIPTION OF DRAWINGS

Various embodiments in accordance with the present disclosure will be described with reference to the drawings, in which:

FIG. 1 is a diagram illustrating an environment for multi-tenant storage for analytics with push down filtering according to some embodiments.

FIG. 2 is a diagram illustrating data flow in an environment for multi-tenant storage for analytics with push down filtering according to some embodiments.

FIG. 3 is a diagram illustrating an example storage node according to some embodiments.

FIG. 4 is a diagram illustrating an example of query plan division according to some embodiments.

FIG. 5 is a flow diagram illustrating operations of a method for multi-tenant storage for analytics with push down filtering according to some embodiments.

FIG. 6 illustrates an example provider network environment according to some embodiments.

FIG. 7 is a block diagram of an example provider network that provides a storage service and a hardware virtualization service to customers according to some embodiments.

FIG. 8 is a block diagram illustrating an example computer system that may be used in some embodiments.

### DETAILED DESCRIPTION

Various embodiments of methods, apparatus, systems, and non-transitory computer-readable storage media for multi-tenant storage for analytics with push down filtering are described. According to some embodiments, a multi-tenant storage service can include resources can be grouped into racks, with each rack providing a distinct endpoint to which client services, such as query engines, may submit queries. Query processing can be pushed down to the racks, which may include a plurality of interface nodes and a plurality of storage nodes. The interface nodes can preprocess queries that are received by splitting them into chunks (e.g., one or more operations to be performed on a stream of data) to be executed by the storage nodes. The interface node can send the operations based on the request to the storage nodes. Each storage node includes a field programmable gate array (FPGA) configured as a stream processor and a CPU. The CPU can receive the operations from the interface node and convert the operations into instructions that can be executed by the FPGA. The instructions may include pointers to data stored on the storage node and operations for the FPGA to perform on the data as it streams through. The CPU can then provide the instructions to the FPGA to process the data stream and return the results of the processing. The results can be returned to the interface node which returns the results to the requestor.

Data lakes provide a centralized repository for customer data, including structured and unstructured data. This allows customers to store all of their data in whatever formats or types it is available in a single place. However, data lakes may not be accessible by multiple client tools. For example, data lakes are often implemented such that data can only be added to or retrieved from the data lake using its own interface. This limits that access analytics tools that are available, but which may not be able to access the customer's data without requiring the customer to first transfer the data out of the data lake and added to a source that is accessible to the analytics tool. This also limits the ability to use multiple analytics tools in combination.

Additionally, the infrastructure underlying large storage services cannot be scaled to provide a multi-tenant data lake to multiple customers. This is at least in part that these storage services typically retrieve data from various storage locations within the storage service and reassembling the data. This requires transferring large amounts of data over the network before it can be processed and leads to networking and CPU bottlenecks, reducing performance.

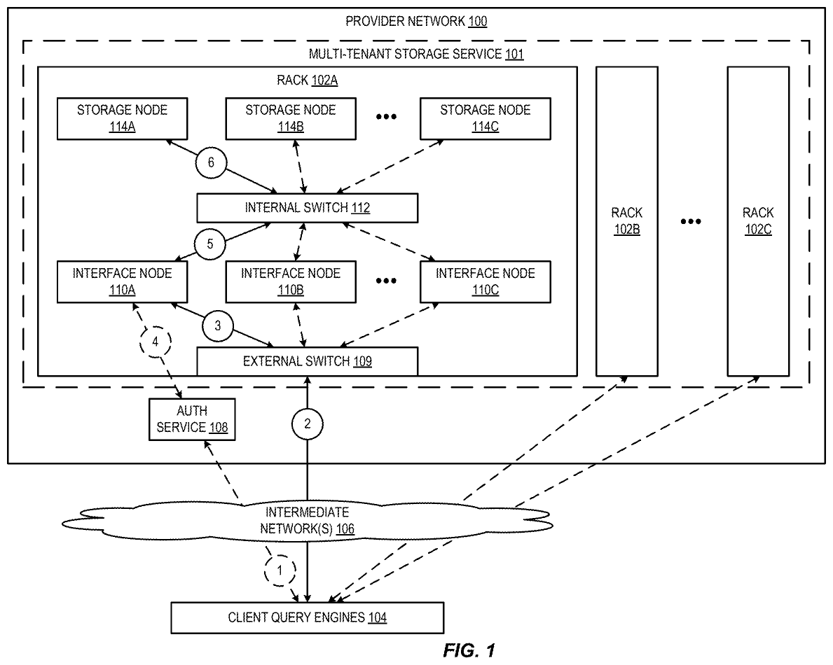

FIG. 1 is a diagram illustrating an environment for multi-tenant storage for analytics with push down filtering according to some embodiments. Embodiments address these shortcomings by providing a storage infrastructure that can interface with various client services and pushes down processing to storage nodes. This enables the data to be processed locally at the storage nodes with only the results of the processing (e.g., query results, etc.) being transferred over the network. In various embodiments, a provider network 100 can provide a multi-tenant storage service 101 which includes sets of resources can be grouped into racks 102A-102C. Each rack can provide a distinct endpoint (e.g., external switch 109) to which client query engines 104 may connect to submit requests, the processing of which can be pushed down, to the racks. Each rack 102 may include a plurality of interface nodes 110A-110C and a plurality of storage nodes 114A-114C. Although equal numbers of interface nodes and storage nodes are shown in FIG. 1, in various embodiments the number of interface nodes may be greater than or less than the number of storage nodes, depending on performance requirements, storage requirements, etc. High-speed, in-rack networking allows any interface node to communicate with any storage node through internal switch 112.

A provider network 100 provides users with the ability to utilize one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources may be provided as services, such as a hardware virtualization service that can execute compute instances, a storage service that can store data objects, etc. The users (or “customers”) of provider networks 100 may utilize one or more user accounts that are associated with a customer account, though these terms may be used somewhat interchangeably depending upon the context of use. Users may interact with a provider network 100 across one or more intermediate networks 106 (e.g., the internet) via one or more interface(s), such as through use of application programming interface (API) calls, via a console implemented as a website or application, etc. The interface(s) may be part of, or serve as a front-end to, a control plane of the provider network 100 that includes “backend” services supporting and enabling the services that may be more directly offered to customers.

To provide these and other computing resource services, provider networks 100 often rely upon virtualization techniques. For example, virtualization technologies may be used to provide users the ability to control or utilize compute instances (e.g., a VM using a guest operating system (O/S) that operates using a hypervisor that may or may not further operate on top of an underlying host O/S, a container that may or may not operate in a VM, an instance that can execute on “bare metal” hardware without an underlying hypervisor), where one or multiple compute instances can be implemented using a single electronic device. Thus, a user may directly utilize a compute instance hosted by the provider network to perform a variety of computing tasks, or may indirectly utilize a compute instance by submitting code to be executed by the provider network, which in turn utilizes a compute instance to execute the code (typically without the user having any control of or knowledge of the underlying compute instance(s) involved).

A user can access the multi-tenant storage service 101 through one or more client query engines 104. The client query engines may include various client services such as various SQL services and non-SQL services. The multi-tenant storage service 101 stores data from multiple customers. In some embodiments, to ensure a requestor can access requested data, at numeral 1, the requestor can be authorized by an authorization service 108. At numeral 2, a request can be sent to the multi-tenant storage service 101, the request including an authorization token that was received from the authorization service 108 at numeral 1. The request may include all or a portion of a query execution plan to be executed by the storage node or nodes that include the requested data. In some embodiments, a query can be provided to one or more client query engines 104. The client query engine(s) can generate a query execution plan and can divide the execution plan into one or more sub-plans. The query execution plan and sub-plans may be represented as query trees. All or a portion of the trees can be serialized and sent to the rack 102A that includes the data to be processed. In some embodiments, the portions of the query trees that are sent to the rack in the request can include operations that are supported by the rack, such as scan and aggregation portions of query execution plans to be performed locally at the storage nodes. In various embodiments, the multi-tenant storage service 101 can publish a list of operations that are supported by the racks 102.

In some embodiments, a client query engine can generate a query execution plan for a query received from a user or other entity. Data, such as a table data, stored in storage nodes 114A-114C can be identified by their existence in external schemas. In some embodiments, the client query engine can receive data manifest information from the multi-tenant storage service 101 to be used to perform code generation. The client query engine can identify a subplan from the query that includes operations supported by the multi-tenant storage service 101. In some embodiments, the multi-tenant storage service can periodically publish a library of supported operations. Client query engines, or other client services, can consume this library by using it to run a technology mapping algorithm on the query tree representing the query execution plan. In various embodiments, technology mapping algorithms may be used for different client query engines.

The request can be received at the rack 102A by an external switch 109. The external switch can be the endpoint through which the rack is accessed by the client query engines. The external switch can route the request to an interface node 110A at numeral 3. In some embodiments, the request can be routed to an interface node specified in the request. In some embodiments, the request can be load balanced across the plurality of interface nodes 110 in the rack 102A. The interface node 110A receives the request and parses the request to determine what data is being processed. In some embodiments, as shown at numeral 4, the interface node 110A can authorize the request with the authorization service 108 before passing the request to a storage node for processing. For example, the interface node may authorize the request when the request does not include an authorization token. In some embodiments, the interface node may communicate directly with the authorization service or may communicate through the external switch or other entity to authorize the request with the authorization service.

Each interface node can maintain a catalog of data stored on the storage nodes of the rack and use the catalog to determine which storage node or storage nodes includes the data to be processed to service the request. As discussed, the interface node can receive a serialized subtree of a query execution plan. The interface node can preprocess the serialized subtree by splitting it into chunks (e.g., one or more operations to be performed on a stream of data) to be executed by the storage nodes. The interface node can send the operations based on the request to the storage node 114A at numeral 5 via internal switch 112 which routes the operations to the storage node 114A at numeral 6. Each storage node 114 includes custom digital logic (CDL), such as implemented in a field programmable gate array (FPGA) which is configured as a stream processor and a CPU. In some embodiments, the CDL can be implemented in an application-specific integrated circuit (ASIC), graphics processing unit (GPU), or other processor. The CPU can receive the operations from the interface node and convert the operations into instructions that can be executed by the CDL. The instructions may include pointers to data stored on the storage node and operations for the CDL to perform on the data as it streams through. The CPU can then provide the instructions to the CDL to process the data stream and return the results of the processing. The results can be returned to the interface node which returns the results to the requestor. Although the example shown in FIG. 1 shows an interface node communicating with a single storage node, in various embodiments, an interface node may communicate with multiple storage nodes to execute a sub-query.

As discussed further below, each storage node includes an CDL which connects to a plurality of storage drives (e.g., hard drives, SSD drives, etc.). Unlike past storage nodes which are connected via a host bus, embodiments include storage nodes where each CDL acts as a hub for the storage drives. Additionally, each CDL can be configured as a stream processing engine which can process a series of operations (e.g., numerical comparisons, data type transformations, regular expressions, etc.) and then stream the data through the CDL for processing. Using CDL to perform these operations does not reduce throughput when operating on data from the drives in the storage node. Additionally, traditional data lakes provide storage for various types of data doing storage, while analysis of the stored data was performed separately by another service that retrieved all of the data to be processed from the data lake before processing the data, discarding most of the data, and returning a result. This limited the scalability of such a service due to the very high data transfer requirements. However, embodiments process the data first locally in the data lake, as discussed above, providing a highly scalable analytics solution.

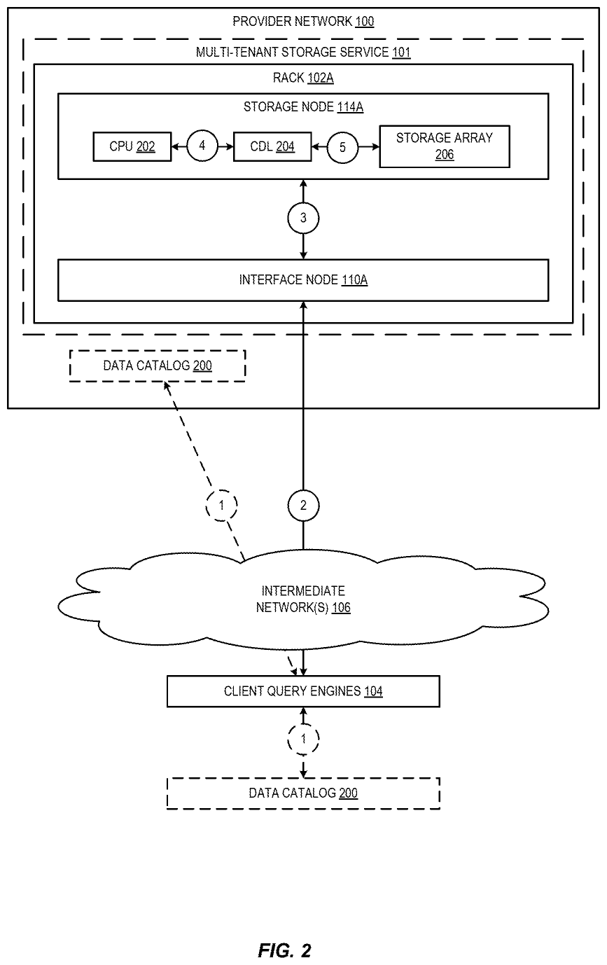

FIG. 2 is a diagram illustrating data flow in an environment for multi-tenant storage for analytics with push down filtering according to some embodiments. FIG. 2 shows an overview of the data flow between a client query engine 104 (or other client service) and multi-tenant storage service 101. Although a single interface node and storage node are shown in the embodiment of FIG. 2, this is for simplicity of illustration. As discussed above with respect to FIG. 1, each rack 102 can include a plurality of storage and interface nodes.

As shown in FIG. 2, at numeral 1 the client query engine 104 can send a request to a data catalog 200 for an endpoint for the rack that includes the data to be processed by the query. The request can include identifiers associated with the data to be processed (e.g., table names, file names, etc.). The data catalog can be maintained by provider network 100 or separately by a client system or third-party service. The data catalog can return a set of endpoints associated with the racks that include the requested data. In some embodiments, if a particular piece of data is stored in multiple racks, the client query engine may select a single endpoint to which to send the request. If the request fails, another request may be sent to a different endpoint that includes the requested data. Using the endpoint retrieved from data catalog 200, at numeral 2, the client query engine 104 can send a message that indicates the portion of the data set being requested and the operations to be performed on that data. In some embodiments, the request from the client query engine may include a sub-query from a larger query. The client query engine can identify that the sub-query can be processed by the storage nodes. The client query engine can send a serialized representation of the query tree corresponding to the sub-query.

The interface node 110 can receive the request and determine which storage node includes data to be processed by the request. The interface node can preprocess the request, by dividing the request into a plurality of instructions and, at numeral 3, sends the preprocessed version of this to the storage node. Each storage node may include a CPU 202, CDL 204, and a storage array 206. For example, the storage array may include a plurality of storage drives (e.g., SSD drives or other storage drives). The CPU 202 can convert the request into a series of CDL requests and at numeral 4 issues those requests to the CDL 204. In some embodiments, the CDL requests may include a series of data processing instructions (also referred to herein as “analytics instructions”) and a series of data locations.

The data processing instructions may include a variety of data transformations, predicates, etc., to be performed by the CDL. For example, the instructions may include an instruction to transform each input data element (e.g., extend an input X byte integer to be a Y byte integer, etc.). The instructions may also include instructions to add or subtract a first constant value to or from the extended data element and then compare the result to a second constant and populate a bit vector to include a ‘1’ when the result was greater than the second constant. Based on the instructions from the CPU, the CDL can be instructed to perform the tasks defined in the data processing instructions on the data stored in the data locations. For example, where the CDL is implemented in an FPGA, the FPGA (or configured analytics processors within the FPGA) can be instructed to configure a preprogrammed set of data pipelines to perform the requested data processing instructions.

A second sequence of instructions can be sent by the CPU which includes addresses of where the data to be processed are stored. The CDL can then use the data locations and, at numeral 5, initiate data transfer from the storage array 206 over a data connection (such as PCIE) to the CDL 204. The CDL routes the data through the data pipelines and produces an output bit vector. In various embodiments, such processing may be performed on multiple data sets (e.g., multiple columns from a table) and the resulting bit vectors may be combined. A new set of instructions can then be provided to apply that resulting bit vector to another data set and output only those elements of the data set that correspond to the ‘1’ values in the bit vector. This provides high stream processing rates to apply transformations and predicates to the data, transferring only the results of the data processing over the network connection to the client query engines via the interface node in response.

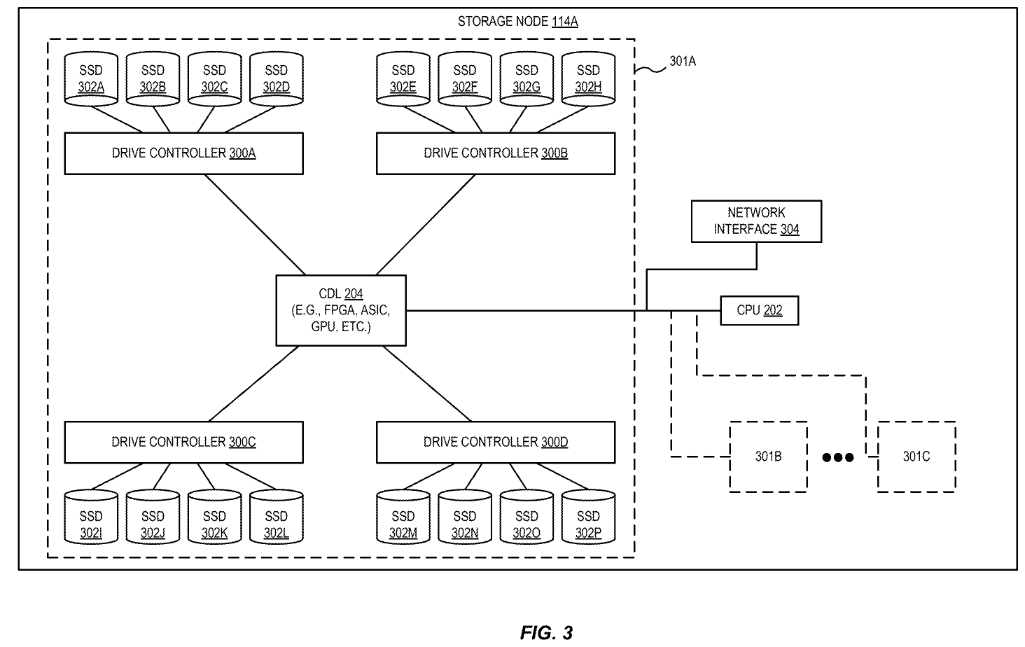

FIG. 3 is a diagram illustrating an example storage node according to some embodiments. As shown in FIG. 3, a storage node 114A may include CDL 204 and a CPU 202. As discussed, the CDL may include an FPGA, ASIC, GPU, or other processor. In some embodiments, the CDL may implement a stream processor which is configured to execute SQL-type streaming operations. The CDL can be configured once and then can be instructed to execute analytics instructions that are assembled by the CPU to perform requested data processing operations. The CDL 204 can connect to a plurality of storage drives 302A-302P through a plurality of drive controllers 300A-300D. In this implementation, the CDL serves as a hub, where the CDL obtains data from the storage drives 302, performs the requested data processing operations (e.g., filtering), and returns the resulting processed data. This way, the CDL processes data as it is passed through the CDL, improving throughput of the storage node. Each storage node can include a network interface 304 through which the storage node can communicate with the interface nodes within the same rack. In various embodiments, the network interface 304 may be a peer to the CDL. This allows the CPU to receive data directly through the network interface without having to have the data routed to the CPU by the CDL.

In various embodiments, the CDL, rather than the CPU, can initiate reads and writes on the storage drives 302. In some embodiments, each drive controller (such as an NVME interface) can perform compression, space management, and/or encryption of the data as it is passed through the network interface to or from the CDL. As a result, the CDL can process data in plaintext, without having to first decompress and/or decrypt the data. Likewise, the CDL can write data to a storage location without first having to compress and/or encrypt the data. In some embodiments, the CDL can perform compression and/or encryption rather than the drive controller.

Although FIG. 3 shows an embodiment with a single CPU and CDL, in various embodiments, a storage node may include a plurality of CDLs and/or CPUs. For example, storage node 114A may include multiple storage systems (e.g., as indicated at 301A-301C), where each storage system 301A-301C includes a CDL as a hub of storage devices. Additionally, or alternatively, embodiments may include multiple CPUs. For example, each storage system 301A-301C may be associated with a separate CPU or, as shown in FIG. 3, multiple storage systems may share a CPU where each storage system is a peer of the others.

In some embodiments, all CDLs (e.g., FPGAs, ASICs, etc.) may be configured to be the same type of stream processor. In some embodiments, different CDLs may be configured based on the type of data being stored on the storage devices connected to the CDL. For example, if a storage system is storing geo-spatial data, the CDL in that storage system may be specialized for performing operations on geo-spatial data, while CDL on a different storage system or different storage node may be configured to perform operations on a wide variety of data types.

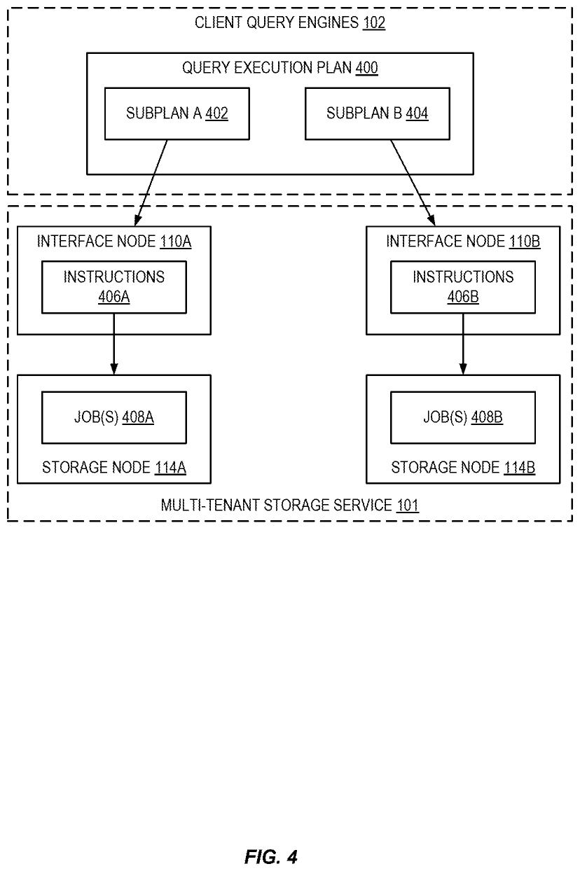

FIG. 4 is a diagram illustrating an example of query plan division according to some embodiments. As shown in FIG. 4, a client query engine 102 can generate a query execution plan 400 for a query. The query execution plan may include multiple subplans 402 and 404. Each subplan may include one or more operations to be performed as part of the query and may represent subtrees within the tree representation of the query execution plan. Each subplan can be verified to include operations that can be performed by the multi-tenant storage service 101, based on libraries published by the multi-tenant storage service. Once the subplans have been verified, they can be serialized and sent to an interface node on a rack that includes the data to be processed. As shown in FIG. 4, different subplans may be sent to different interface nodes for processing, these may be different interface nodes on the same rack, or on different racks. Alternatively, multiple subplans may be sent to the same interface node for processing.

The incoming requests can be validated by the interface nodes to ensure they include operations that are supported by the multi-tenant storage service. This validation may also include identifying a portion of each subplan that can be executed within a storage node. In some embodiments, a subset of the library of operations supported by the multi-tenant storage service can be used to identify operations that are supported by the storage nodes themselves.

In some embodiments, each interface node can maintain an internal catalog with a mapping of data slices to storage nodes. Given a query subplan, the interface node then uses this catalog to determine which storage node on the rack it is to communicate with to apply the query subplan to the entirety of the data (e.g., the entire table that is being processed). The interface node can generate instructions 406A, 406B identifying portions of data on the storage node to be processed and the operations from the subplan to be performed on the data. These instructions can be sent to the storage node.

As described above, each storage node may include an FPGA with two interfaces: one to an array of storage drives and a second to a CPU. Interface nodes can communicate to storage nodes in the same rack over the network with the CPU, which in turn communicates with the CDL through a hardware abstraction layer (HAL). The HAL interface is used to submit instructions 406A and 406B to the CDL that either set it up for a new job (e.g., an analytics instruction), request that a stream of data be pulled through the current configuration (e.g., a data instruction), or manage allocation of CDL memory for bitmaps. When an instruction is received from an interface node, the storage node can decompose the instruction into a plurality of jobs 408A, 408B. In some embodiments, an instruction from the interface node can include a set of independent query subplans, and each independent query subplan results in a different job.

In some embodiments, each storage node can maintain metadata for each block stored on its associated storage drives. Any constants in the subplan can be compared to this metadata for each block to remove blocks from consideration that cannot include relevant values. This process will effectively reduce, and potentially fragment, any data range provided in the instruction. In some embodiments, the metadata may include minimum and maximum values found in each block along with the number of values in that block, thereby providing block-level filtering.

The independent subplan representing each job can be traversed by the interface node in order to break it up into a number of analytics instructions where each analytics instruction represents a pass over the data on the CDL. The portion of the subplan that is representable in a single analytics instruction is related to the number of stages in each filter unit in the CDL. Separately, the data ranges from the previous step can be further broken down along block boundaries since each data ticket must reference a contiguous piece of data on disk.

If more than one analytics instruction is required to complete the execution of a job, then space in the CDL memory may be allocated to store a bitmap which represents the intermediate results of the job. The first configuration can populate the first bitmap, the second configuration will consume the first bitmap and populate the second bitmap, and so on. In some embodiments, a analytics instruction is submitted followed by all corresponding data instructions. This process is repeated until all analytics instructions for a single job have been submitted. As the CDL applies the given computations to the requested data, the results are streamed into the memory of the CPU, such as through direct memory access (DMA). Once all results have been received from the CDL, or once a configurable amount of results specified in the instructions 406A, 406B have been received from the CDL, the processor can forward the results to the interface node that sent the instructions. In some embodiments, this forwarding may be done via strided DMA such that the values from the result data are directly placed into the correct positions in the awaiting batch. Once the data has been processed the results are returned to the interface node to be routed back to the requestor client query engine.

In some embodiments, where the CDL is implemented in an FPGA, the FPGA can be configured as a stream processor and then instructed to execute each query using analytics instructions that have been generated to process that query. For example, the FPGA may be configured to include a plurality of soft processors that are specialized for analytics processing. When a query is received the soft processors can be configured to execute a subquery on a set of data locations. The analytics instructions generated for each subquery may be used to configure these soft processors. Alternatively, the FPGA can be reconfigured for each query (e.g., to include different soft processors that are specialized to execute different operations).

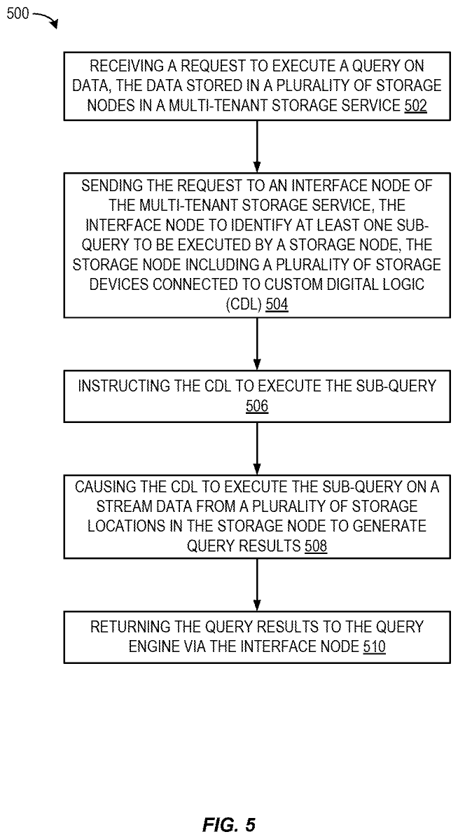

FIG. 5 is a flow diagram illustrating operations 500 of a method for multi-tenant storage for analytics with push down filtering according to some embodiments. Some or all of the operations 500 (or other processes described herein, or variations, and/or combinations thereof) are performed under the control of one or more computer systems configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some embodiments, one or more (or all) of the operations 500 are performed by the multi-tenant storage service 101, authorization service 108, or client query engines 104 of the other figures.

The operations 500 include, at block 502, receiving a request to execute a query on data, the data stored in a plurality of storage nodes in a multi-tenant storage service. In some embodiments, the request includes a serialized representation of a query execution plan corresponding to the query. In some embodiments, the request is received from one of a plurality of analytics engines configured to generate a query execution plan corresponding to the query.

The operations 500 include, at block 504, sending the request to an interface node of the multi-tenant storage service, the interface node to identify at least one sub-query to be executed by a storage node, the storage node including a plurality of storage devices connected to custom digital logic (CDL). In some embodiments, the CDL includes a first interface to connect to the plurality of storage devices and a second interface to connect to a processor, the processor to configure the CDL to execute the sub-query and to provide the CDL with a plurality of data instructions including pointers to locations of the data on the plurality of storage devices. In some embodiments, the custom digital logic is implemented in one or more of a field programmable gate array (FPGA), application-specific integrated circuit (ASIC), or graphics processing unit (GPU).

The operations 500 include, at block 506, instructing the CDL to execute the sub-query. In some embodiments, configuring the CDL to execute the sub-query may include generating at least one analytics instruction by the interface node based on the sub-query, and sending the at least one analytics instruction to the processor of the storage node, the processor to configure a set of data pipelines in the CDL to implement at least a portion of the sub-query.

The operations 500 include, at block 508, causing the CDL to execute the sub-query on a stream data from a plurality of storage locations in the storage node to generate query results. The operations 500 include, at block 510, returning the query results via the interface node. In some embodiments, returning the query results via the interface node may include streaming the query results to a memory of the processor, the processor to return a subset of the query results to the interface node once a configurable amount of the query results have been received by the processor.

In some embodiments, the interface node identifies the storage node to execute the sub-query using a catalog with a mapping of data to storage nodes. In some embodiments, a query engine sends a request to a data catalog to obtain an endpoint in the multi-tenant storage service to which to send the request to execute the query, the request to the data catalog.

In some embodiments, the operations may further include publishing a library of supported operations, the library to validate the sub-query before it is sent to the CDL to be executed. In some embodiments, the operations may further include obtaining an authorization token from the request, and verifying the authorization token with an authorization service to authorize the request.

In some embodiments, the operations include receiving a request, from a query engine, to execute a query on customer data, the customer data stored in a plurality of storage nodes in a multi-tenant storage service, the request including a serialized representation of a query execution plan generated for the query by the query engine, authorizing the request with an authorization service, sending the request to an interface node of a rack of the multi-tenant storage service, the interface node to identify at least one sub-plan in the serialized representation of the query execution plan to be executed by a storage node, generating analytics instructions and data instructions based on the at least one sub-plan, identifying at least one storage node that includes the customer data, sending the analytics instructions and the data instructions to the at least one storage node, executing the analytics instructions, by the at least one storage node, to instruct custom digital logic (CDL) to execute the sub-plan, executing the data instructions to stream data from a plurality of storage locations in the storage node through the CDL, the CDL to execute the sub-plan on the data as it streams through the CDL to generate query results, and returning the query results to the query engine via the interface node.

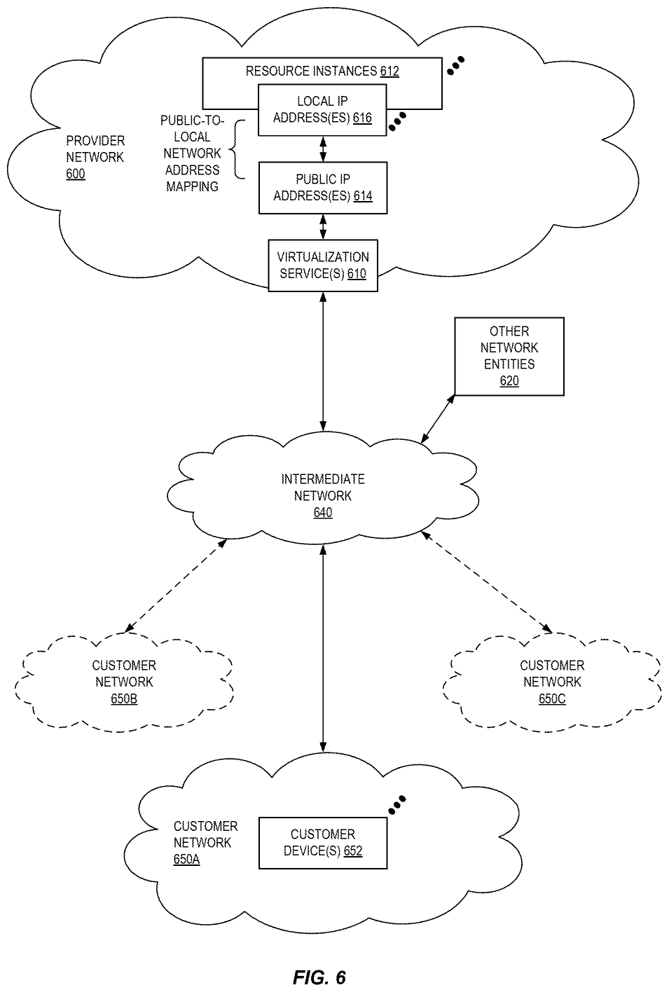

FIG. 6 illustrates an example provider network (or “service provider system”) environment according to some embodiments. A provider network 600 may provide resource virtualization to customers via one or more virtualization services 610 that allow customers to purchase, rent, or otherwise obtain instances 612 of virtualized resources, including but not limited to computation and storage resources, implemented on devices within the provider network or networks in one or more data centers. Local Internet Protocol (IP) addresses 616 may be associated with the resource instances 612; the local IP addresses are the internal network addresses of the resource instances 612 on the provider network 600. In some embodiments, the provider network 600 may also provide public IP addresses 614 and/or public IP address ranges (e.g., Internet Protocol version 4 (IPv4) or Internet Protocol version 6 (IPv6) addresses) that customers may obtain from the provider 600.

Conventionally, the provider network 600, via the virtualization services 610, may allow a customer of the service provider (e.g., a customer that operates one or more client networks 650A-650C including one or more customer device(s) 652) to dynamically associate at least some public IP addresses 614 assigned or allocated to the customer with particular resource instances 612 assigned to the customer. The provider network 600 may also allow the customer to remap a public IP address 614, previously mapped to one virtualized computing resource instance 612 allocated to the customer, to another virtualized computing resource instance 612 that is also allocated to the customer. Using the virtualized computing resource instances 612 and public IP addresses 614 provided by the service provider, a customer of the service provider such as the operator of customer network(s) 650A-650C may, for example, implement customer-specific applications and present the customer's applications on an intermediate network 640, such as the Internet. Other network entities 620 on the intermediate network 640 may then generate traffic to a destination public IP address 614 published by the customer network(s) 650A-650C; the traffic is routed to the service provider data center, and at the data center is routed, via a network substrate, to the local IP address 616 of the virtualized computing resource instance 612 currently mapped to the destination public IP address 614. Similarly, response traffic from the virtualized computing resource instance 612 may be routed via the network substrate back onto the intermediate network 640 to the source entity 620.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193, and may be mutable within the provider network. Network traffic originating outside the provider network is not directly routed to local IP addresses; instead, the traffic uses public IP addresses that are mapped to the local IP addresses of the resource instances. The provider network may include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses may be assigned by the provider network infrastructure to particular resource instances; these public IP addresses may be referred to as standard public IP addresses, or simply standard IP addresses. In some embodiments, the mapping of a standard IP address to a local IP address of a resource instance is the default launch configuration for all resource instance types.

At least some public IP addresses may be allocated to or obtained by customers of the provider network 600; a customer may then assign their allocated public IP addresses to particular resource instances allocated to the customer. These public IP addresses may be referred to as customer public IP addresses, or simply customer IP addresses. Instead of being assigned by the provider network 600 to resource instances as in the case of standard IP addresses, customer IP addresses may be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

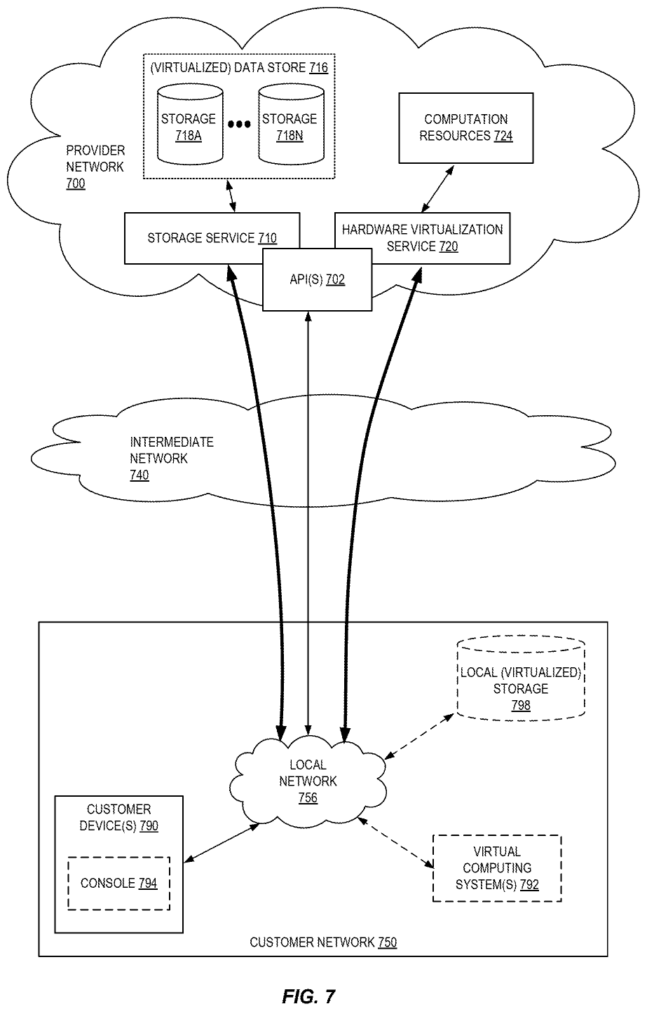

FIG. 7 is a block diagram of an example provider network that provides a storage service and a hardware virtualization service to customers, according to some embodiments. Hardware virtualization service 720 provides multiple computation resources 724 (e.g., VMs) to customers. The computation resources 724 may, for example, be rented or leased to customers of the provider network 700 (e.g., to a customer that implements customer network 750). Each computation resource 724 may be provided with one or more local IP addresses. Provider network 700 may be configured to route packets from the local IP addresses of the computation resources 724 to public Internet destinations, and from public Internet sources to the local IP addresses of computation resources 724.

Provider network 700 may provide a customer network 750, for example coupled to intermediate network 740 via local network 756, the ability to implement virtual computing systems 792 via hardware virtualization service 720 coupled to intermediate network 740 and to provider network 700. In some embodiments, hardware virtualization service 720 may provide one or more APIs 702, for example a web services interface, via which a customer network 750 may access functionality provided by the hardware virtualization service 720, for example via a console 794 (e.g., a web-based application, standalone application, mobile application, etc.). In some embodiments, at the provider network 700, each virtual computing system 792 at customer network 750 may correspond to a computation resource 724 that is leased, rented, or otherwise provided to customer network 750.

From an instance of a virtual computing system 792 and/or another customer device 790 (e.g., via console 794), the customer may access the functionality of storage service 710, for example via one or more APIs 702, to access data from and store data to storage resources 718A-718N of a virtual data store 716 (e.g., a folder or “bucket”, a virtualized volume, a database, etc.) provided by the provider network 700. In some embodiments, a virtualized data store gateway (not shown) may be provided at the customer network 750 that may locally cache at least some data, for example frequently-accessed or critical data, and that may communicate with storage service 710 via one or more communications channels to upload new or modified data from a local cache so that the primary store of data (virtualized data store 716) is maintained. In some embodiments, a user, via a virtual computing system 792 and/or on another customer device 790, may mount and access virtual data store 716 volumes via storage service 710 acting as a storage virtualization service, and these volumes may appear to the user as local (virtualized) storage 798.

While not shown in FIG. 7, the virtualization service(s) may also be accessed from resource instances within the provider network 700 via API(s) 702. For example, a customer, appliance service provider, or other entity may access a virtualization service from within a respective virtual network on the provider network 700 via an API 702 to request allocation of one or more resource instances within the virtual network or within another virtual network.

### Illustrative System

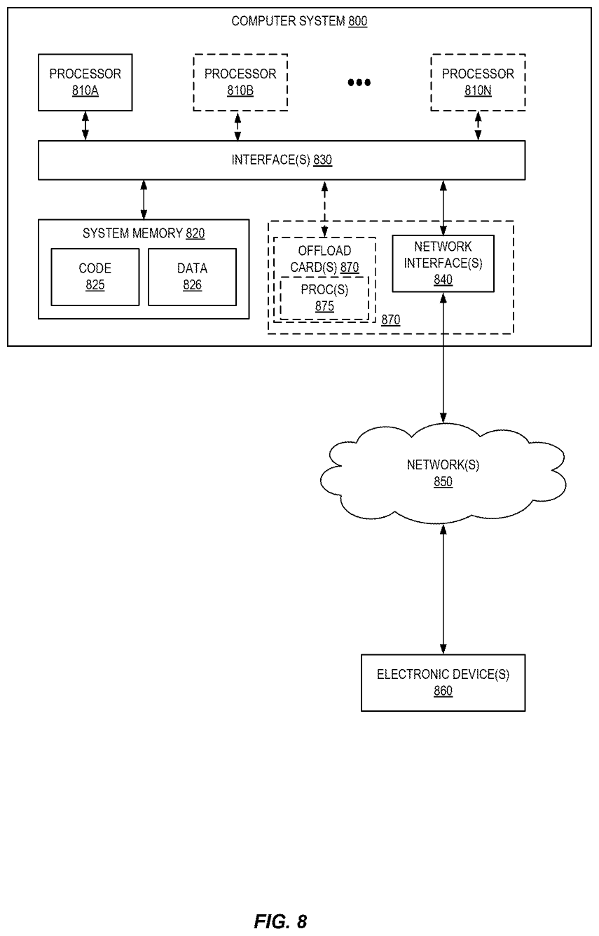

In some embodiments, a system that implements a portion or all of the techniques for multi-tenant storage for analytics with push down filtering as described herein may include a general-purpose computer system that includes or is configured to access one or more computer-accessible media, such as computer system 800 illustrated in FIG. 8. In the illustrated embodiment, computer system 800 includes one or more processors 810 coupled to a system memory 820 via an input/output (I/O) interface 830. Computer system 800 further includes a network interface 840 coupled to I/O interface 830. While FIG. 8 shows computer system 800 as a single computing device, in various embodiments a computer system 800 may include one computing device or any number of computing devices configured to work together as a single computer system 800.

In various embodiments, computer system 800 may be a uniprocessor system including one processor 810, or a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x86, ARM, PowerPC, SPARC, or MIPS ISAs, or any other suitable ISA. In multiprocessor systems, each of processors 810 may commonly, but not necessarily, implement the same ISA.

System memory 820 may store instructions and data accessible by processor(s) 810. In various embodiments, system memory 820 may be implemented using any suitable memory technology, such as random-access memory (RAM), static RAM (SRAM), synchronous dynamic RAM (SDRAM), nonvolatile/Flash-type memory, or any other type of memory. In the illustrated embodiment, program instructions and data implementing one or more desired functions, such as those methods, techniques, and data described above are shown stored within system memory 820 as code 825 and data 826.

In one embodiment, I/O interface 830 may be configured to coordinate I/O traffic between processor 810, system memory 820, and any peripheral devices in the device, including network interface 840 or other peripheral interfaces. In some embodiments, I/O interface 830 may perform any necessary protocol, timing or other data transformations to convert data signals from one component (e.g., system memory 820) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to system memory 820, may be incorporated directly into processor 810.

Network interface 840 may be configured to allow data to be exchanged between computer system 800 and other devices 860 attached to a network or networks 850, such as other computer systems or devices as illustrated in FIG. 1, for example. In various embodiments, network interface 840 may support communication via any suitable wired or wireless general data networks, such as types of Ethernet network, for example. Additionally, network interface 840 may support communication via telecommunications/telephony networks such as analog voice networks or digital fiber communications networks, via storage area networks (SANs) such as Fibre Channel SANs, or via I/O any other suitable type of network and/or protocol.

In some embodiments, a computer system 800 includes one or more offload cards 870 (including one or more processors 875, and possibly including the one or more network interfaces 840) that are connected using an I/O interface 830 (e.g., a bus implementing a version of the Peripheral Component Interconnect-Express (PCI-E) standard, or another interconnect such as a QuickPath interconnect (QPI) or UltraPath interconnect (UPI)). For example, in some embodiments the computer system 800 may act as a host electronic device (e.g., operating as part of a hardware virtualization service) that hosts compute instances, and the one or more offload cards 870 execute a virtualization manager that can manage compute instances that execute on the host electronic device. As an example, in some embodiments the offload card(s) 870 can perform compute instance management operations such as pausing and/or un-pausing compute instances, launching and/or terminating compute instances, performing memory transfer/copying operations, etc. These management operations may, in some embodiments, be performed by the offload card(s) 870 in coordination with a hypervisor (e.g., upon a request from a hypervisor) that is executed by the other processors 810A-810N of the computer system 800. However, in some embodiments the virtualization manager implemented by the offload card(s) 870 can accommodate requests from other entities (e.g., from compute instances themselves), and may not coordinate with (or service) any separate hypervisor.

In some embodiments, system memory 820 may be one embodiment of a computer-accessible medium configured to store program instructions and data as described above. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 800 via I/O interface 830. A non-transitory computer-accessible storage medium may also include any volatile or non-volatile media such as RAM (e.g., SDRAM, double data rate (DDR) SDRAM, SRAM, etc.), read only memory (ROM), etc., that may be included in some embodiments of computer system 800 as system memory 820 or another type of memory. Further, a computer-accessible medium may include transmission media or signals such as electrical, electromagnetic, or digital signals, conveyed via a communication medium such as a network and/or a wireless link, such as may be implemented via network interface 840.

In the preceding description, various embodiments are described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Bracketed text and blocks with dashed borders (e.g., large dashes, small dashes, dot-dash, and dots) are used herein to illustrate optional operations that add additional features to some embodiments. However, such notation should not be taken to mean that these are the only options or optional operations, and/or that blocks with solid borders are not optional in certain embodiments.

Reference numerals with suffix letters (e.g., 102A-102C, 110A-110C, 114A-114C, 300A-300D, 302A-302P, 406A, 406B, 408A, 408B, and 718A-718N) may be used to indicate that there can be one or multiple instances of the referenced entity in various embodiments, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters may or may not have the same number of instances in various embodiments.

References to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Moreover, in the various embodiments described above, unless specifically noted otherwise, disjunctive language such as the phrase “at least one of A, B, or C” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A computer-implemented method comprising:
receiving a request, from a query engine, to execute a query on customer data, the customer data stored in a plurality of storage nodes in a multi-tenant storage service, the request including a serialized representation of a query execution plan generated for the query by the query engine;
authorizing the request with an authorization service;
sending the request to an interface node of a rack of the multi-tenant storage service, the interface node to identify at least one sub-plan in the serialized representation of the query execution plan to be executed by a storage node;
generating analytics instructions and data instructions based on the at least one sub-plan;
identifying at least one storage node that includes the customer data;
sending the analytics instructions and the data instructions to the at least one storage node;
executing the analytics instructions, by the at least one storage node, to instruct custom digital logic to execute the sub-plan;
executing the data instructions to stream data from a plurality of storage locations in the storage node through the custom digital logic, the custom digital logic to execute the sub-plan on the data as it streams through the custom digital logic to generate query results; and
returning the query results to the query engine via the interface node.

2. The computer-implemented method of claim 1, wherein the custom digital logic is implemented in one or more of a field programmable gate array (FPGA), application-specific integrated circuit (ASIC), or graphics processing unit (GPU).

3. The computer-implemented method of claim 1, wherein authorizing the request with an authorization service further comprises:
sending, by the query engine, a request to the authorization service to authorize a requestor associated with the query, the request including a credential associated with the requestor; and
receiving an authorization token from the authorization service.

4. A computer-implemented method comprising:
receiving a request to execute a query on data, the data stored in a plurality of storage nodes in a multi-tenant storage service;
sending the request to an interface node of the multi-tenant storage service, the interface node to identify at least one sub-query to be executed by a storage node, the storage node including a plurality of storage devices connected to custom digital logic;
instructing the custom digital logic to execute the sub-query;
causing the custom digital logic to execute the sub-query on a stream data from a plurality of storage locations in the storage node to generate query results; and
returning the query results via the interface node.

5. The computer-implemented method of claim 4, wherein the custom digital logic includes a first interface to connect to the plurality of storage devices and a second interface to connect to a processor, the processor to instruct the custom digital logic to execute the sub-query and to provide the custom digital logic with a plurality of data instructions including pointers to locations of the data on the plurality of storage devices.

6. The computer-implemented method of claim 5, wherein returning the query results via the interface node, further comprises:
streaming the query results to a memory of the processor, the processor to return a subset of the query results to the interface node once a configurable amount of the query results have been received by the processor.

7. The computer-implemented method of claim 5, wherein instructing the custom digital logic to execute the sub-query further comprises:
generating at least one analytics instruction by the interface node based on the sub-query; and
sending the at least one analytics instruction to the processor of the storage node, the processor to configure a set of data pipelines in the custom digital logic to implement at least a portion of the sub-query.

8. The computer-implemented method of claim 4, wherein the interface node identifies the storage node to execute the sub-query using a catalog with a mapping of data to storage nodes.

9. The computer-implemented method of claim 4, wherein the request includes a serialized representation of a query execution plan corresponding to the query.

10. The computer-implemented method of claim 4, further comprising:
publishing a library of supported operations, the library to validate the sub-query before it is sent to the custom digital logic to be executed.

11. The computer-implemented method of claim 4, wherein a query engine sends a request to a data catalog to obtain an endpoint in the multi-tenant storage service to which to send the request to execute the query.

12. The computer-implemented method of claim 4, further comprising:
obtaining an authorization token from the request; and
verifying the authorization token with an authorization service to authorize the request.

13. The computer-implemented method of claim 4, wherein the request is received from one of a plurality of analytics engines configured to generate a query execution plan corresponding to the query.

14. The computer-implemented method of claim 4, wherein the custom digital logic is implemented in one or more of a field programmable gate array (FPGA), application-specific integrated circuit (ASIC), or graphics processing unit (GPU).

15. A system comprising:
a client query engine implemented by a first one or more electronic devices; and
a multi-tenant storage service implemented by a second one or more electronic devices, the multi-tenant storage service including instructions that upon execution cause the multi-tenant storage service to:
receive a request to execute a query on data, the data stored in a plurality of storage nodes in a multi-tenant storage service;
send the request to an interface node of the multi-tenant storage service, the interface node to identify at least one sub-query to be executed by a storage node, the storage node including a plurality of storage devices connected to custom digital logic;
instruct the custom digital logic to execute the sub-query;
cause the custom digital logic to execute the sub-query on a stream data from a plurality of storage locations in the storage node to generate query results; and
return the query results via the interface node.

16. The system of claim 15, wherein the custom digital logic includes a first interface to connect to the plurality of storage devices and a second interface to connect to a processor, the processor to configure the custom digital logic to execute the sub-query and to provide the custom digital logic with a plurality of data instructions including pointers to locations of the data on the plurality of storage devices.

17. The system of claim 16, wherein returning the query results via the interface node, further comprises:
streaming the query results to a memory of the processor, the processor to return a subset of the query results to the interface node once a configurable amount of the query results have been received by the processor.

18. The system of claim 16, wherein to instruct the custom digital logic to execute the sub-query, the instructions when executed further cause the multi-tenant storage service to:
generating at least one analytics instruction by the interface node based on the sub-query; and
sending the at least one analytics instruction to the processor of the storage node, the processor to configure a set of data pipelines in the custom digital logic to implement at least a portion of the sub-query.

19. The system of claim 15, wherein the instructions when executed further cause the multi-tenant storage service to:
publish a library of supported operations, the library to validate the sub-query before it is sent to the custom digital logic to be executed.

20. The system of claim 15, wherein a query engine sends a request to a data catalog to obtain an endpoint in the multi-tenant storage service to which to send the request to execute the query, the request to the data catalog.
